(19) United States
(12) Patent Application Publication
(10) Pub. No.: US 2024/0215630 A1
(43) Pub. Date: Jul. 4, 2024

(54) FOAMER INGREDIENT IN THE FORM OF A POWDER AND METHOD FOR MANUFACTURING THE SAME

(71) Applicant: FRIESLANDCAMPINA NEDERLAND B.V., Amersfoort (NL)

(72) Inventors: Paul Bastiaan VAN SEEVENTER, Meppel (NL); Thom HUPPERTZ, Ede (NL); Wilbert WILLEMS, Wageningen (NL); Jan EDING, Ruinen (NL); Janine Henriët BOOIJ-VEURINK, Geerdijk (NL)

(73) Assignee: FRIESLANDCAMPINA NEDERLAND B.V., Amersfoort (NL)

(21) Appl. No.: 18/607,252

(22) Filed: Mar. 15, 2024

Related U.S. Application Data
(63) Continuation of application No. PCT/EP2022/075640, filed on Sep. 15, 2022.

(30) Foreign Application Priority Data
Sep. 16, 2021 (EP) 21197076.9

(51) Int. Cl. A23P 30/40; A21D 2/18; A21D 2/26; A21D 8/02; A21D 13/80; A23P 10/47

(52) U.S. Cl. CPC A23P 30/40; A21D 2/18; A21D 2/26; A21D 8/025; A21D 13/80; A23P 10/47

(57) ABSTRACT

The present invention pertains to a foamer ingredient in the form of a powder comprising one or more carbohydrates; at least 0.5% by weight and less than 5% by weight, based on the total weight of the foamer ingredient in the form of a powder, of one or more proteins having a protein-bound phosphorus to nitrogen ratio of less than 0.03 g/g and having a proline content of less than 7 g per 100 g of protein; and entrapped gas, said foamer ingredient in the form of a powder releases gas when dissolved in a liquid. It furthermore pertains to a method of manufacturing the same, and, finally, to the use of the foamer ingredient in the form of a powder in food products and the products thus obtained.

### CROSS-REFERENCE TO RELATED APPLICATIONS

This application is a continuation of International Application No. PCT/EP2022/075640 filed Sep. 15, 2022, which application claims priority to European Patent Application EP21197076.9 filed Sep. 16, 2021, both of which applications are incorporated herein by reference.

### FIELD OF THE INVENTION

The invention relates to a foamer ingredient in the form of a powder comprising entrapped gas, said foamer ingredient releasing gas when dissolved in a liquid. The invention also relates to food products comprising such a foamer ingredient. The invention further relates to a method for manufacturing a foamer ingredient in the form of a powder comprising entrapped gas. Finally, the invention relates to use of said foamer ingredient.

### BACKGROUND TO THE INVENTION

Nowadays, there is a trend towards instant alternatives for drinks and food products, as preparing these products in the conventional manner is often time-consuming or complicated. Hence, in order to accommodate consumer preferences, many instant food and drink products have been developed in recent years, which have the same or similar characteristics as the conventionally prepared foodstuffs and drinks. Many of these conventionally prepared drinks or foodstuffs for which an instant alternative is sought, include some kind of froth or foam. For example, cappuccino, milk shakes, and some soups, sauces and desserts comprise froth or foam. One challenge for manufacturers is to produce a food product having froth or foam from an instant foodstuff or instant drink item.

One prior solution used to manufacture an instant food product which has froth or foam is through the use of powdered foaming compositions which produce foam upon reconstitution in a liquid. Foaming powder compositions have been used to impart froth or foamed texture to a wide variety of foods and beverages. For example, foaming compositions have been used to impart froth or foamed texture to instant cappuccino and other coffee mixes, instant refreshing beverage mixes, instant soup mixes, instant milkshake mixes, instant dessert toppings, instant sauces, hot or cold cereals, and the like, when combined with water, milk, or another suitable liquid.

WO 2009/089326 A1 relates to foam-creating compositions containing a dairy composition, a hydrocolloid composition, and a foam stabilizer. It is disclosed that such a foam-creating composition provides a convenient form to prepare beverage concentrates, beverage syrups, and beverages. The foam-creating composition imparts a beverage with a thick, creamy head of foam when the beverage is shaken and then poured. It is furthermore described that beverages prepared from the foam-crating composition can contain a dissolved gas under pressure. It is mentioned that in such a case, the gas can be provided in the beverage by forceful introduction of the gas under pressure to the beverage composition. More particularly, it is disclosed that the gas can either be added to the finished, beverage composition, or it can be added to a desired volume of water or other suitable liquid to form a water/suitable liquid containing dissolved gas, which is subsequently combined with a composition such as a beverage concentrate or beverage syrup to produce the finished beverage composition.

WO 2018/224537 A1 relates to a beverage powder comprising porous particles and partially aggregated proteins, the porous particles having an amorphous continuous phase comprising a sweetener, a soluble filler and optionally a surfactant, wherein the porous particles have a closed porosity of between 10 and 80%. The beverage powder is manufactured by subjecting an aqueous composition comprising partially aggregated protein to high pressure, for example 50 to 300 bar, adding gas, and drying the mixture, preferably via spray drying. Said beverage powder does not contain entrapped gas (gas under pressure).

EP 0813815 A1 discloses a foaming creamer composition which is either a gas-injected foaming creamer or a creamer containing chemical carbonation ingredients which contains in excess of 20% protein by weight. The powder described has as essential ingredients, protein, lipid and filler material, the filler especially being a water-soluble carbohydrate. The high content of protein is needed to obtain a whipped cream-like, tight foam having spoonability.

EP 1206193 B1 discloses a powdered soluble foamer ingredient for producing enhanced foam in foodstuffs and beverages, the ingredien comprising a matrix containing carbohydrate and protein and entrapped gas under pressure, the ingredient being obtainable by subjecting porous particles of the matrix to an atmosphere of the gas at a raised pressure and a temperature above the glass transition temperature of the particles; and quenching or curing the particles.

EP 1557091 A1 relates to a powdered soluble foamer ingredient which comprises a matrix containing carbohydrate and protein and entrapped gas, the gas being present in an amount to release upon addition of liquid at least about 1 ml of gas ambient conditions per gram of soluble foamer ingredient.

EP 2025238 A1 discloses a powdered soluble foamer ingredient which comprises a matrix containing carbohydrate and protein-like ingredient and entrapped gas under pressure, the gas being present in an amount to release upon addition of liquid at least 1 ml of gas under standard temperature and pressure conditions (STP) per gram of soluble foamer ingredient, wherein the powdered soluble foamer ingredient has a density of from 200 g/l to 500 g/l and has a closed porosity.

The inventors have found that many prior art foamer ingredients have the drawback that they leak significant quantities of gas over time. This is undesired as a typical application of such foamer ingredients is in instant products (such as in instant soup mixes, instant coffee mixes, instant dessert toppings, and the like). These instant products have a preferred shelf life of more than 12 months, often even up to 24 months. Foaming ingredients which leak gas during storage are 25 detrimental to the quality of such products comprising them, and may even be responsible for a shortening of the shelf life.

A foamer ingredient with improved gas encapsulation in time is described in EP 1793686 B1. This European patent discloses a foaming composition comprising a powdered protein-free soluble composition comprising carbohydrate particles having a plurality of internal voids containing entrapped pressurized gas, said foaming composition comprising less than 1% protein by weight, wherein said soluble composition further comprises a non-protein surfactant, and wherein the carbohydrate is selected from the group consisting of a sugar, polyhydric alcohol, sugar alcohol, oligosaccharide, polysaccharide, starch hydrolysis product, gum, soluble fiber, modified starch, modified cellulose, and mixture thereof. A drawback of such a foamer ingredient, however, is that such a foamer ingredient does not offer product advantages of, int. al., good foam quality (in structure and stability) and a clean and neutral taste.

There is a need for a foamer ingredient in the form of a powder comprising entrapped gas, which, when dissolved in a liquid, generates a foam or froth of good quality and stability, which foamer ingredient has improved shelf stability and limited gas leakage in time, and preferably has a neutral taste and applicability over a wide pH range. In this way, the foamer ingredient is suitable for use in a variety of different applications.

### SUMMARY OF THE INVENTION

It was found that the aforesaid objective could be met by providing a foamer ingredient in the form of a powder comprising carbohydrates, low quantities of a protein with specific characteristics, and entrapped gas.

More particularly, in a first aspect, the invention relates to a foamer ingredient in the form of a powder comprising
a) one or more carbohydrates;
b) at least 0.5% by weight and less than 5% by weight, based on the total weight of the powdered foamer ingredient, of one or more proteins having a protein-bound phosphorus to nitrogen ratio of less than 0.03 g/g and having a proline content of less than 7 g per 100 g of protein; and
c) entrapped gas,
   wherein said foamer ingredient in the form of a powder releases at least 3 ml of gas per gram of foamer ingredient upon dissolving the foamer ingredient in a liquid, preferably water, of 20° C., at atmospheric pressure.

In a second aspect, the invention relates to a method for manufacturing such a foamer ingredient in the form of a powder. More particularly, it relates to a method for manufacturing a foamer ingredient in the form of a powder comprising entrapped gas comprising the following steps:
(a) preparing a mixture comprising carbohydrates and one or more proteins having a protein-bound phosphorus to nitrogen ratio of less than 0.03 g/g and having a proline content of less than 7 g per 100 g of protein, with the total amount of protein being chosen such that in the foamer ingredient as formed in step (f), the total amount of protein is at least 0.5% by weight and less than 5% by weight, with said mixture being in the form of a powder;
(b) optionally blending said mixture with one or more additives;
(c) applying external pressure exceeding atmospheric pressure to the mixture as prepared in step (a) or (b), preferably applying a pressure of between 2 and 4 MPa;
(d) heating the mixture of step (c) to a temperature above 90° C.;
(e) cooling the mixture of step (d) to a temperature between 40 and 80° C.; and
(f) releasing the external gas pressure, resulting in the foamer ingredient in the form of a powder comprising entrapped gas, wherein said foamer ingredient releases at least 3 ml of gas per gram of foamer ingredient upon dissolving the foamer ingredient in a liquid, preferably water, of 20° C., at atmospheric pressure.

In a third aspect, the invention relates to food products comprising the foamer ingredient according to the invention.

In a fourth aspect, the invention relates to the use of the foamer ingredient of the invention to generate or induce a foam or froth in food products and/or to aerate food products such as desserts, sauces, soups, beverages, bakery products, and confectionary products.

### DETAILED DESCRIPTION OF THE INVENTION

In a first aspect, the invention relates to a foamer ingredient in the form of a powder comprising
a) one or more carbohydrates;
b) at least 0.5% by weight and less than 5% by weight, based on the total weight of the powdered foamer ingredient, of one or more proteins having a protein-bound phosphorus to nitrogen ratio of less than 0.03 g/g and having a proline content of less than 7 g per 100 g of protein; and
c) entrapped gas,
   wherein said foamer ingredient in the form of a powder releases at least 3 ml of gas per gram of foamer ingredient upon dissolving it in a liquid, preferably water, of 20° C., at atmospheric pressure.

The foamer ingredient in the form of a powder according to the invention has a particularly good gas leakage stability and, as a result, it has a prolonged shelf life. Preferably, the gas content in the foamer ingredient in the form of a powder according to the present invention does not reduce more than 20% when stored for 12 months at ambient conditions.

A particular useful and unexpected feature of the foamer ingredient is that it shows acid-stability as opposed to the foamer compositions of the prior art. Consequently, hardly, preferably no flocculation is observed in liquids or beverages that have a pH of below 6, preferably below a pH of 5, prepared with the foamer ingredient of the invention. Preferably, hardly or more preferably no flocculation is observed in liquids that have a pH higher than 2.5.

The foamer ingredient in the form of a powder preferably has a particle size characterized by a d(10) of 40-80 micron. Preferably the foamer ingredient has a particle size characterized by a d(50) of 110-160 micron. Preferably the foamer ingredient has a particle size characterized by a d(90) of 200-330 micron.

The d(10), d(50) and d(90) are powder characteristics know in the art and can be determined using a laser diffraction instrument, such as a Mastersizer®. It is preferred that the foamer ingredient is essentially in amorphous state. Preferably, more than 85 wt. %, more preferably more than 90 wt. %, most preferably more than 95 wt. % of the foamer ingredient is in amorphous state.

Proteins suitable for use in the foamer ingredient of the present invention are proteins having a protein-bound phosphorus to nitrogen ratio of less than 0.03 gram per gram of protein. Preferably, the proteins have a protein-bound phosphorus to nitrogen ratio of less than 0.02 g per gram of protein, more preferably less than 0.01 g per gram of protein, most preferably less than 0.0075 g per gram of protein.

The protein-bound phosphorus to nitrogen ratio is determined as described in J. Dairy Res. 25 (1958), J. C. D White and D. T. Davies, page 236-255: “The relation between the chemical composition of milk and the stability of the caseinate complex.”, with the proviso that the colorimetric assay used therein is replaced by the ICP-OES (inductively coupled plasma optical emission spectrometry) method as described in ISO 15151 (IDF 229): “Milk, milk products, infant formula and adult nutritionals—Determination of minerals and trace metals’ in combination with AOAC 2011.14 (Calcium, Copper, Magnesium, Manganese, Potassium, Phosphorous, Sodium, and Zinc in fortified food products”).

In this method, total phosphorous and acid-soluble phosphorous of proteins is determined. The difference between the two methods results in the amount of protein-bound phosphorous.

Nitrogen content in the protein is determined according to ISO 8968-4:2016(en): Milk and milk products—Determination of nitrogen content—Part 4: Determination of protein and non-protein nitrogen content and true protein content calculation.

The proteins suitable for use in the foamer ingredient of the present invention further have a proline content of less than 7 g per 100 g of protein, more preferably less than 6.5 g per 100 g protein, most preferably less than 6.0 g per 100 g protein. The proline content of a protein is determined as described in S. H. M. Gorissen et al., Amino Acids (2018) 50:1685-1695, “Protein content and amino acid composition of commercially available plant-based protein isolates.”

In the foamer ingredient of the present invention, one type of protein can be used, but it is also possible to use two or more types of protein. In one embodiment, protein(s) are used having a sensory neutral taste and/or flavor within the foaming ingredient and in its further application. In another embodiment, protein(s) are selected being low in allergen, thus excluding e.g. soy protein and wheat protein.

Suitable sources of proteins include dairy proteins and plant-based proteins. A combination of dairy proteins and plant-based proteins can also be used. In one embodiment according to the invention, the proteins are selected from the group consisting of potato protein; canola protein; pea protein; faba bean protein; oat protein; rice protein; sunflower protein; lupin protein, corn protein; algal protein; whey protein concentrate; whey protein isolate; and hydrolysates thereof. Suitable commercially available whey protein concentrates are WPC30, WPC35, WPC60, and WPC80.

Whey protein concentrates (e.g. WPC80 sold under the name Textrion Progel 80 and whey protein hydrolysates (e.g. Hyvital HA 300), and whey protein isolate (Nutri Whey Native I) may be obtained from FrieslandCampina, The Netherlands. Pea protein hydrolysates may be obtained from Kerry, Ireland (Hyfoama Pro). Pea protein may be obtained from Cargill, the Netherlands (Radipure E), or from Roquette, France, (Nutralys Plus N). Potato protein (Solanic 300) may be obtained from AVEBE, the Netherlands. Canola or rapeseed protein (Puratein HS) may be obtained from Merit Foods, Canada.

The whey protein concentrates or whey protein isolates used are preferably in an essentially native, undenatured state. Hence, preferably the whey proteins are for more than 80%, more preferably for more than 85%, most preferably for more than 90% native. The native state of whey proteins may be measured using differential scanning calorimetry. The whey proteins may be derived from acid whey or cheese whey, preferably cheese whey.

The proteins of the invention are present in the foamer ingredient of the present invention in a total amount of less than 5% by weight, preferably of less than 4.8% by weight, most preferably less than 3% by weight, based on the total weight of the foamer ingredient in the form of a powder. The total amount of proteins of the invention in the foamer ingredient is preferably at least 0.5% by weight, more preferably at least 1% by weight, even more preferably at least 1.2% by weight, and most preferably at least 2% by weight, based on the total weight of the foamer ingredient in the form of a powder.

Preferably, the foamer ingredient in the form of a powder of the present invention contains less than 0.5% by weight, more preferably less than 0.25% by weight, and even more preferably less than 0.1% by weight of proteins that do not fulfill the requirements of having a protein-bound phosphorus to nitrogen ratio of less than 0.03 g/g and a proline content of less than 7 g per 100 g of protein. Most preferably, the foamer ingredient of the invention does not comprise proteins other than the proteins having a protein-bound phosphorus to nitrogen ratio of less than 0.03 g/g and having a proline content of less than 7 g per 100 g of protein.

The foamer ingredient in the form of a powder preferably may have a moisture content of between 0-5% by weight, more preferably 1-4%, most preferably 2-3%. The water activity preferably lies between 0 and 0.5, more preferably between 0.05 and 0.4, and most preferably between 0.1 and 0.3.

The foamer ingredient in the form of a powder comprises preferably between 80% and 98% by weight of carbohydrates, based on the total weight of said foamer ingredient. More preferably, it comprises between 85% and 97% by weight of carbohydrates, more preferably still between 88% and 96% by weight of carbohydrates, and most preferably, between 90% and 95% by weight of carbohydrates.

The term “carbohydrate” means any carbohydrate that is compatible with the end use of the powder of the invention. In practice, this will mean that the carbohydrate must be acceptable for consumption.

Carbohydrates suitable for use in the foamer ingredient in the form of a powder of the present invention include sugars, polyhydric alcohols, sugar alcohols, oligosaccharides, polysaccharides, starch hydrolysis products, gums, soluble fibers, modified starches, and modified celluloses. Suitable sugars include glucose, fructose, sucrose, lactose, mannose, and maltose. Suitable polyhydric alcohols include glycerol, propylene glycol, polyglycerols, and polyethylene glycols. Suitable sugar alcohols include sorbitol, mannitol, maltitol, lactitol, erythritol, and xylitol. Suitable starch hydrolysis products include maltodextrins, glucose syrups, corn syrups, high-maltose syrups, and high-fructose syrups. Suitable gums include xanthan, alginates, carrageenan, guar, gellan, locust bean, and hydrolyzed gums. Suitable soluble fibers include inulin, hydrolyzed guar gum, and polydextrose. Suitable modified starches include physically or chemically modified starches that are soluble or dispersible in water. A good example is nOSA-modified starch. Suitable modified celluloses include methylcellulose, carboxymethyl cellulose, and hydroxypropyl methyl cellulose.

The carbohydrate or the mixture of carbohydrates is selected such that the foaming composition structure is sufficiently strong to retain gas enclosed under pressure.

In one embodiment of the present invention, the foamer ingredient in the form of a powder further comprises one or more additives. Suitable additives include additives such as foam stabilizers, emulsifiers, processing aids, surfactants, and other additives conventionally used in similar applications. Suitable foam stabilizers may preferably be selected from DATEM, SSL, and saponins such as quillaia. Suitable stabilizers may preferably be selected from trisodium citrate, dipotassium phosphate and disodium phosphate. The total amount of additives in the foamer ingredient in the form of a powder preferably lies between 0 and 8% by weight, more preferably between 0.1 and 6% by weight, most preferably between 0.2-2% by weight based on the total weight of the foamer ingredient in the form of a powder. More preferably, the total amount of additives is less than 4% by weight, based on the total weight of the foamer ingredient in the form of a powder. Most preferably, the total amount of additives is less than 2% by weight, based on the total weight of the foamer ingredient in the form of a powder. In one embodiment of the invention, one or more additives are used selected from the group consisting of tricalcium phosphate, calcium carbonate, silicon dioxide, milk calcium and milk minerals.

The foamer ingredient of the invention comprises entrapped gas. The term “entrapped gas” as used throughout the specification means that gas having a pressure greater than atmospheric pressure is present in the foaming composition structure. Preferably, the gas is not able to escape from this structure, without opening or dissolving the powder structure. Preferably, the majority of the pressurized gas present in the foaming composition structure is contained physically within internal voids of the powder structure. These voids are capable of holding a large volume of entrapped gas. In one embodiment, the foamer ingredient in the form of a powder according to the invention releases at least 3 ml of entrapped gas per gram of said foamer ingredient upon dissolving it in a liquid, preferably water, of 20° C., at atmospheric pressure. Preferably, the foamer ingredient of the invention releases between 4 and 20 ml/g of gas, more preferably between 5 and 19 ml/g, more preferably still between 8 and 18 ml/g, and most preferably between 12 and 16 ml/g of gas, when dissolved in a liquid, preferably water, of 20° C., at atmospheric pressure. Preferably, said amount of gas is released when dissolving 1,000 gram (one gram) of foamer ingredient in 10 ml of water.

Gases that can suitably be used according to the present invention can be selected from nitrogen, carbon dioxide, nitrous oxide, air, or mixture thereof. Nitrogen is preferred, but any other food-grade gas can be used to entrap pressurized gas in the powder structure.

Entrapped gas is released as bubbles upon dissolution of the foamer ingredient in the form of a powder in liquid, thus generating or inducing a foam or froth. The foamer ingredient in the form of a powder may also be used to aerate food products. Examples of food products that may be aerated are soups, sauces, beverages, confectionary products, desserts, and bakery products such as muffins and cakes.

The liquid wherein the foamer ingredient in the form of a powder according to the invention is preferably dissolved is preferably an aqueous liquid. More preferably, the aqueous liquid comprises coffee beverages, tea beverages, milk beverages, fruit beverages, vegetable beverages such as soy-, almond-, or oat beverages, iced beverages such as slush ice. The aqueous liquid may be hot, preferably between 30° C.-100° C., or cold, preferably between 29° C.-0° C.

The foamer ingredient of the invention may typically be prepared from its spray dried, non-pressurized composition that has a bulk density in the range of 0.1-0.30 g/cm³, typically 0.2-0.29 g/cm³ and an internal void volume in the range of 5-80%, typically 10-75%, before subjecting to external gas pressure. Powders with relatively large internal void volumes are generally preferred because of their greater capacity to entrap gas.

An advantage of the foamer ingredient in the form of a powder is that it preferably has a high density and high gas content. Accordingly, the foamer ingredient according to the invention preferably has a bulk density of 0.30-0.7 g/cm³, more preferably 0.35-0.65 g/cm³, most preferably 0.40-0.60 g/cm³. The foamer ingredient according to the invention preferably has a gas tight volume GTVV of 15-60%, more preferably 20-50%, most preferably 30-45%. Internal void volume also defined as gas tight void volume (GTVV) (%), is the volume percent of sealed internal voids contained in the particles comprising the powder.

The foamer ingredient of the invention typically has a T_{g} between 30-150° C., most typically between 40-125° C., and most typically between 50-100° C.

Bulk density (g/cm³) is determined by measuring the volume (g/cm³) that a given weight (g) of material occupies when poured through a funnel into a graduated cylinder. Skeletal density (g/cm³) is determined by measuring the volume of a weighed amount of powder using a helium pycnometer (Micromeritics AccuPyc II 1340) and dividing weight by volume. Skeletal density is a measure of density that includes the volume of any voids present in the particles that are sealed to the atmosphere and excludes the interstitial volume between particles and the volume of any voids present in the particles that are open to the atmosphere. The volume of sealed voids, referred to herein as internal voids, is derived from also measuring the skeletal density of the powder after grinding with mortar and pestle to remove or open all internal voids to the atmosphere. This type of skeletal density, referred to herein as true density (g/cm³), is the actual density of only the solid matter comprising the powder. Internal void volume also defined as gas tight void volume (GTVV) (%), the volume percent of sealed internal voids contained in the particles comprising the powder, is determined by subtracting the reciprocal true density (cm³/g) from the reciprocal skeletal density (cm³/g) and then multiplying the difference by skeletal density (g/cm³) and 100%.

The glass transition temperature (T_{g}) marks a secondary phase change characterized by transformation of the powder composition from a rigid glassy state to a softened rubbery state. In general, gas solubilities and diffusion rates are higher in materials at or above the T_{g}. The T_{g} is dependent on chemical composition and moisture level and, in general, lower average molecular weight and/or higher moisture will lower T_{g}. The T_{g} can intentionally be raised or lowered by simply decreasing or increasing, respectively, the moisture content of the powder using any suitable method known to one skilled in the art. The T_{g} can be measured using established Differential Scanning calorimetry or Thermal Mechanical Analysis techniques. A suitable instrument to measure the T_{g} is DSC1 Differential Scanning calorimeter from Mettler Toledo.

Moisture may be determined using a KarlFischer method, e.g. using 831 KF Coulometer from Metrohm.

In another aspect, the invention relates to a method for manufacturing a foamer ingredient in the form of a powder comprising entrapped gas, said method comprising the following steps:
(a) preparing a mixture comprising carbohydrates and one or more proteins having a protein-bound phosphorus to nitrogen ratio of less than 0.03 g/g and having a proline content of less than 7 g per 100 g of protein, with the total amount of protein being chosen such that in the foamer ingredient as formed in step (f), the total amount of protein is at least 0.5% by weight and less than 5% by weight, with said mixture being in the form of a powder;
(b) optionally blending said mixture with one or more additives;
(c) applying external gas pressure exceeding atmospheric pressure to the mixture as prepared in step (a) or (b), preferably applying a pressure of between 2 and 4 MPa;
(d) heating the mixture of step (c) to a temperature above 90° C.;
(e) cooling the mixture of step (d) to a temperature between 40 and 80° C.; and
(f) releasing the external gas pressure, resulting in the foamer ingredient in the form of a powder comprising entrapped gas,
   wherein said foamer ingredient in the form of a powder releases at least 3 ml of gas per gram of foamer ingredient upon dissolving it in a liquid, preferably water, of 20° C., at atmospheric pressure.

Step (a) of the method of the present invention can be carried out in any conventional way. Preferably, however, the mixture of step (a) is prepared using a spray drying technique. More preferably, the mixture of step a) is prepared by preparing an aqueous solution or dispersion comprising the carbohydrates and one or more proteins having a protein-bound phosphorus to nitrogen ratio of less than 0.03 g/g, and subsequently spray-drying the aqueous solution or dispersion to obtain a powder.

The mixture as prepared in step (a) of the method according to the invention may be blended in a next step (b) with one or more additives.

In one embodiment, the mixture as obtained in step (a) or (b) is subjected to an external pressure exceeding atmospheric pressure, preferably a pressure of between 2.5 and 3.5 MPa. Subsequently, the mixture is heated to a temperature above 90° C. Steps (c) and (d) can be performed in any suitable pressure vessel known in the art. It is preferred that the heating step (d) is carried out 20-35° C. higher than the T_{g} of the mixture prepared in step (a) or (b).

In one embodiment, when step (d) is carried out in a suitable pressure vessel, step (e) is carried out by cooling the powder either by rapid release of pressure or by cooling the vessel prior to depressurization.

In a next step, step (f), the external gas pressure is released, resulting in the foamer ingredient in the form of a powder according to the present invention comprising entrapped gas. Said foamer ingredient in the form of a powder releases at least 3 ml of gas per gram of foamer ingredient upon dissolving it in a liquid, preferably water, of 20° C., at atmospheric pressure.

In one embodiment, steps (d), (e), and (f), are carried out as follows: the powder as prepared in step (a) or (b) of the method according to the invention is sealed in a pressure vessel and pressurized with compressed gas, then the pressure vessel is heated either by placing in a preheated oven or bath or by circulation of electric current (i.e. electric heating) or hot fluid through an internal coil or external jacket to increase the temperature of the powder to above the T_{g} of said powder for a period of time effective to fill internal voids in the particles with pressurized gas, the still pressurized vessel containing the powder is then cooled to a temperature of preferably between 25-80° C., more preferably between 35-75° C., even more preferably between 40-65° C., most preferably between 50-60° C. The pressure is then released and the vessel opened to recover the foaming ingredient of the invention. The foaming ingredient can be produced in batches or continuously using any suitable means.

Typically, the mixture in the form of a powder as prepared in step (a) or (b) is heated in step (c) at a temperature in the range of 90-200° C., preferably 93-175° C., and more preferably 95-150° C., most preferably 100-135° C. typically for 1-300 minutes, preferably 5-200 minutes, and more preferably 10-150 minutes. The pressure inside the pressure vessel is typically in the range of 2-4 MPa, preferably 2.2-3.7 MPa, and most preferably 2.5-3.5 MPa. Use of nitrogen gas is preferred, but any other food-grade gas can be used to pressurize the vessel, including air, carbon dioxide, nitrous oxide, or mixture thereof. Powder gas content and foaming capacity generally increase with processing pressure. Heating can cause the initial pressure delivered to the pressure vessel to increase considerably. The maximum pressure reached inside the pressure vessel during heating can be approximated by multiplying the initial pressure by the ratio of heating temperature to initial temperature using Kelvin units of temperature. At temperatures at or above the T_{g}, particle gas content and foaming capacity increase with processing time until a maximum is reached. The rate of gasification generally increases with pressure and temperature and relatively high pressures and/or high temperatures can be used to shorten processing time. (It is noted that “gasification” is also often denoted as “entrapment of gas under pressure” or “encapsulation of gas under pressure”). However, increasing temperature to greatly beyond what is required for effective processing can make the powder susceptible to collapse. Particle size distribution of the powders is typically not meaningfully altered when gasification is conducted under more preferred conditions. However, significant particle agglomeration or caking can occur when gasification is conducted under less preferred conditions such as excessively high temperature and/or long processing time. It is believed that gas dissolved in the softened gas-permeable solid matter during heating diffuses into internal voids until pressure equilibrium is reached or until the powder is cooled to below the Ty. Therefore, it is to be expected that the cooled particles should retain both pressurized gas entrapped in internal voids and gas dissolved in the solid matter. When powders are pressurized at a temperature at or above the Ty, it is common for some of the particles to explode with a loud cracking sound during a brief time after depressurization due to bursting of localized regions of the particle structure that are too weak to retain the pressurized gas. The foaming compositions retain pressurized gas with good stability when stored below the T_{g} with adequate protection against moisture intrusion. Foaming compositions stored in a closed container at room temperature generally perform well many months later.

In yet another embodiment, the invention relates to a food product comprising the foamer ingredient in the form of a powder as described above. The food product according to the present invention is preferably selected from the group consisting of bakery products, an instant coffee mix, an instant cappuccino mix, instant cocoa mix, an instant tea mix, a dessert product, an ice-cream product, an instant nutrition product, fruit and/or vegetable based beverages, yoghurt, cream cheese, yoghurt, butter milk, smoothies, milkshakes an instant cheese product, an instant cereal product, an instant soup product, and an instant topping product.

Further, the invention relates to the use of the foamer ingredient in the form of a powder according to the invention to generate or induce a foam or froth in food products and/or to aerate food products such as desserts, sauces, soups, beverages, bakery products, and confectionary products.

### Methods

### Determination of Entrapped Gas:

### Materials:

1. Water bath—25° C.
2. Volumetric burette/pipette—50 ml
3. Pipetting balloon
4. Plastic funnel—Ø10-15 cm, outlet 1-1.5 cm
5. Rubber hosing
6. Tripod
7. Scale, 3 digits accurate
8. Vial 25 ml, with septum cap
9. Syringe 10 ml
10. Needle with narrow opening
11. Needle with large opening

### Method:

### Preparation:

1. Remove the conical bottom of the pipette/burette and attach a piece of 5 cm of rubber hosing.
2. Connect the other end of the hose to the outlet of the funnel.
3. Add the pipetting balloon on top of the pipette/burette.
4. Attach the pipette/burette to a tripod and submerge the funnel below the surface of the water in the water bath.
5. Fill the pipette/burette by sucking up liquid from the water bath into the pipette/burette, using the pipetting balloon.
6. Place a beaker with water in water bath to heat up the water.

### Measurement

7. Take a 25 ml vial and fill with 1,000 g of powder—weigh accurately (Mp)
8. Close the vial with a septum cap—weigh accurately (Mvp).
9. Inject ˜10 ml of water, using the needle with narrow opening, shake gently to dissolve the powder (use water from beaker at 25° C.).
10. Place the vial in the water bath below the funnel and puncture the septum with a large hollow needle (hypodermic needle).
11. The overpressure in the vial will leak out and the bubbles will be collected in the pipette/burette (V).
12. After liberating the generated gas the vial can be dried with (paper) towel and weighed accurately (Mvd); measurement of the mass of the vial after gas liberation is essential since a small amount of water might penetrate the vial during puncturing with the hollow needle.

### Calculation:

$$Gc = Vd / Mp$$

where:
G_{c}=gas content of the powder (ml/g)
V_{d}=displaced water volume (ml)
Mₚ=mass of the powder (g)

$$Vd = Vb = Vaw - c$$

where:
V_{d}=displaced water volume (ml)
V_{b}=volume burette (ml)
V_{aw}=volume of added water (ml)
c=correction factor for the empty vial only; the reading of the measurement without any powder added to the vial (ml)

$$Vaw = ( Mad - Mvp ) / ρ T$$

where:
V_{aw}=Volume of added water (g)
M_{ad}=Mass of the vial after drying (g)
Mᵥₚ=Mass of the vial+powder, before water addition (g)
ρ_{T}=Density of water at 25° C.=0.997 g/ml

The correction factor can be obtained by measuring the released air in a vial with no powder added but only the 10 ml of water (see remark 1)

### Foam Test G (Foam Height Measurement):

A cappuccino base-mix was prepared and used for this purpose. 5.5 gr Cappa 26Y (FrieslandCampina, a fat filled milk powder with 26% hardened coconut fat, 24% protein), 4.0 g fine crystalline sugar, 2.0 g instant coffee (DE Rood merk, finely milled). After mixing well, this dry mix was placed in a glass beaker 250 mL with a diameter of 67 mm. The 11.5 g of the Cappuccino base mix was mixed well with an additional 3.0 gram of foamer ingredient according to the invention or foaming products from the prior art (comparative). Then while with stirring by hand with a standard coffee spoon, 150 mL of hot water with a temperature between 87-90° C. was added. Stirring was continued for at least 5 seconds. After stopping stirring the timer was started and foam height was measured in mm after 1 minute and after 10 minutes. Next to foam height also the foam firmness and foam bubble size was evaluated; it was visually assessed if the foam was fine, medium coarse or coarse.

### Foam Test C (Foam Height Measurement in Acidified Beverages):

4 gram of foamer ingredient according to the invention or a foamer product of the prior art (comparative) was placed in a 250 ml beaker with a diameter of 57 mm, was dissolved in 100 mL of cold water (5-10C), that was acidified by the addition of citric acid to a pH of 3.0-3.2 by stirring for at least 20 seconds. The foam height in mm was measured after 2 and 10 minutes.

It was also noted if visually any flocculation occurred. Also foam firmness and foam bubble size was visually evaluated by rating the foam as fine, medium coarse or coarse.

### Gas Leakage/Shelf Life Test Using the Water Displacement Bag Method:

Powders containing entrapped gas (foamers or pressurized foamers such as those according to the invention) may leak some of its entrapped or encapsulated gas, this leaking of gas will create an increase of the volume occupied by the released gas when the powder has been stored in a hermetically sealed bag under ambient storage conditions. The incrementally generated and measured water displacement of the bag by this gas leakage is then a measure for the escaped gas. With this method the gas leakage in time can be determined. Typically extrapolation of the % of gas leakage at a certain time period (1 or 2 months shelf life time) will generate an accurate measure of an estimated shelf life for gas leakage. The % of gas leakage can be calculated from the amount of released gas by taking into account the total amount of encapsulated gas content at the start of the shelf life test. Typically storage at room temperature for shelf life determination has been used in this so-called water displacement bag method.

### Measurement

1. Put 125 g powder in an aluminium-coated (air and moisture tight) bag (12×25 cm). The bag should be filled half.
2. Seal the bag at the top without any additional air above the powder.
3. Take a 3 liter small cylinder of 32 cm, inner Ø 100 mm.
4. Connect the bag to a heavy counterweight.
5. Tare the scale with the cylinder, together with a filled bag and the counterweight.
6. Submerge the bag completely in the cylinder and fill the cylinder with water (20° C.) to the top.
7. Weigh the water that was needed to fill the cylinder.
8. Repeat this measurement at regular times (bi-weekly) for a shelf life estimation.

### Gas Decrease

The gas decrease can be calculated:

$$GDx = \frac{Wi - Wb}{( Mp * GCi )} * 100 \%$$

Where:
GDₓ=Gas decrease after time x
Wᵢ=Water displacement at t=0
W_{b}=Water displacement at t=x
Mₚ=Mass of the powder in the bag
GCᵢ=Gas content of the powder at t=0

The present invention is further exemplified by the following, non-limiting examples.

### EXAMPLES

The following ingredients were used in the Examples:
Sodium caseinate (FrieslandCampina, Excellion EM7); 90% protein
Whey protein concentrate 80 (FrieslandCampina, Textrion Progel 800); 80% protein
Whey protein hydrolysate 80% protein (Hyvital HA 300 FrieslandCampina)
Skimmed milk powder (FrieslandCampina, skimmed milk powder medium Heat MH 1% fat; 33% protein)
NOSA (modified) starch (Ingredion, E1450, Hicap 100)
Glucose syrup (Roquette Glucidex DE28)
Maltodextrin (Roquette Glucidex DE18)
Tricalcium phosphate (Budenheim, E341 iii)
Silicon dioxide E551 (Grace)
Milk minerals (which is rich in calcium and therefore also sometimes denoted as Milk Calcium) (Lactoval R HICAL, FrieslandCampina)
Solanic 300 (potato protein Avebe); 90% protein
Puratein HS (rapeseed protein Merit Foods); 90% protein
Nutralys S85 Plus N, (pea protein), 84% protein
Radipure E, (pea protein, Cargill), 80% protein

### Examples 1A-1C (with Test Numbers 1-8)

Powder mixtures were prepared comprising carbohydrates and one or more proteins having a protein-bound phosphorus to nitrogen ratio of less than 0.03 g/g and a proline content of less than 7 g per 100 g of protein or, in case of a comparative example, a protein with a protein-bound phosphorus to nitrogen ratio of more than 0.03 g/g.

The powder mixture was obtained by dissolving the powdered solids in their relative weight ratios according to the recipe as provided in Table 1A in water to a solids content of 66 wt. %, followed by spray-drying.

This was done in the following way.

The various proteins and glucose syrup (or maltodextrin) or NOSA starch were dispersed while stirring with a propeller stirring device into hot water of around 50-60° C. Subsequently, the carbohydrates (glucose syrup, maltodextrin) were dispersed. For all of the obtained mixes a dry matter content of 60% was applied. The mixture was then heated to 68° C., and further pumped via a 2-stage homogenizer (operating at low pressures; typically 20/10 bar) to a buffer vessel. From this buffer vessel the liquid was pumped via a high heat pasteurizer (heating until 74-80° C. took place for typically 25-30 seconds) with a high pressure pump with capacity of approx. 100 kg/hr. to the high pressure atomizer. Within the high pressure tube the injection of gas was done, using a Maximator gas metering device. The gas was fed into the liquid within the high pressure tube with a speed of 0.05 gr./sec. of nitrogen. Behind the gas injection point an internal gas mixer dispersed the gas into fine microbubbles. The liquid was then fed under high pressure to the Spraying Systems® high pressure nozzle and atomized. The high pressure atomization was performed at a pressure of between 150-170 bar.

The liquid was atomized into a drying chamber of Filtermat spray dryer (brand Filtermat, BMA Braunschweig), and subsequently dried under standard conditions. The powder was obtained by applying T(inlet) temperatures of 150° C. and outlet temperatures of 75-80° C. The powder was transported to the end of the drying section by the moving belt, at that point also the free flowing aid might be added in a dosage of 4% wt/wt or more preferably at 1-3% wt/wt. After the belt the powder was collected by passing over a 2 mm sieve.

Typical powder moisture contents of 2.5-5.0 wt. % were obtained. Bulk densities of 0.210-0.300 g/cm³ were obtained by correctly adjusting the capacity of the liquid feed and the into to this liquid feed metered amount of injected nitrogen gas. The obtained closed pores which were determined by the amount of gas injected were further analyzed as GTVV % and were in the range of 45-70%.

The powders were characterized by several tests: T_{g}, GTVV %, moisture %, density (g/cm³) (see table 1B).

Pressurizing Process to Prepare Powdered Compositions with Entrapped Gas.

The various powders were pressurized with nitrogen gas by applying an external gas pressure to the powder (kg) in a rotating double walled vessel that can be pressurized with nitrogen gas (operating up to 35-40 bar) and heated above the Tg of the powder, with typical maximum process temperatures (Tmax) that were 25-30° C. higher than its corresponding powder Tg.

The vessel was first filled with powder (20 kg). Then, additional free flowing aid in the form of either E551, E341 iii or milk minerals (also denoted as milk calcium) (0.8 kg) was added to this as well before closing the vessel, and starting of pressurization, to ensure entrapment of gas, (applied pressure was 3.5 MPa), which was performed with the vessel wall temperature between 20-40° C., which is well below its powder Tg. The vessel was heated with a speed of max 3° C./min while rotating (8-10 rpm) until Tmax. Once the Tmax was reached the vessel heating was stopped and a period of 10 min was used to keep the powder well above Tg close to Tmax. Cooling with cold water was started with again a speed of max 3 ºC/min, until the powder reached a temperature 35-40° C. At that moment cooling was stopped, the pressure was released and the powder was removed and collected from the pressure vessel.

A set of analyses was executed on the obtained powders having encapsulated gas under high pressure: the results are shown in Table 1C. Next to the encapsulated gas content, GTVV %, density, the gas content at time zero, also the gas leakage over time was analyzed via the so-called water displacement bag method (carried out as described in detail above). With this method the products gas release or leakage in time could be followed non-invasively. Clearly large differences in gas leakage in time were observed for the evaluated variants, showing very unstable, moderately stable and highly stable products after pressurizing, either holding very little or almost all of their initially encapsulated gas.

The P/N ratio of the used proteins was determined according to the methods described earlier in this application (i.e. ICP P and protein and N analysis with TCA partitioning, using as protein conversion factor N×6.38 for milk proteins and N×6.25 for plant proteins). The proline content was also determined as described earlier in this application.

| | Protein | g P per | Pro g/ |
|---|---|---|---|
| Protein source | (% N*6.38 or 6.25) | g N | 100 g |
| NaCas sodium caseinate | 89.5 | 0.0463 | 8.7 |
| WPC80 whey protein | 77.6 | 0.0173 | 4.8 |
| concentrate | | | |
| Radipure E pea protein | 76.9 | 0.0299 | 3.1 |
| isolate | | | |
| Nutralys S85 Plus N pea | 79.2 | 0.0250 | 3.1 |
| protein isolate | | | |
| Solanic 300 potato protein | 89.9 | 0.0001 | 3.3 |
| Puratein HS canola protein | 89.0 | 0.0000 | 5.8 |
| isolate | | | |

TABLE 1
Composition in wt. % of the powders and their characteristics measured.
Table 1A
General composition. (wt. %)

| | 1 comp | 2 comp | 3 comp | 4 comp |
|---|---|---|---|---|
| | SMP | SMP | Glucose | Maltodextrin |
| | 5% | 15% | syrup based | based |
| Test number -> | protein | protein | 0% protein | 0% protein |
| Skimmed milk | 15 | 45 | | |
| powder | | | | |
| Whey protein | | | | |
| concentrate | | | | |
| Sodium caseinate | | | | |
| Whey protein | | | | |
| hydrolysate | | | | |
| NOSA modified | | | 8 | 8 |
| starch | | | | |
| Glucose syrup | 85 | 55 | 92 | |
| DE28 | | | | |
| Maltodextrin | | | | 92 |
| DE18 | | | | |

TABLE 1B
Properties of the spray dried ingredient before pressurizing

| | | | 3 comp | 4 comp |
|---|---|---|---|---|
| | 1 comp | 2 comp | Glucose | Maltodextrin |
| Test | SMP | SMP | syrup based | based |
| number -> | 5% protein | 15% protein | 0% protein | 0% protein |
| GTVV (%) | 52 | 52 | 58 | 57 |
| Moisture | 3.5 | 3.6 | 2.6 | 4.3 |
| (wt. %) | | | | |
| Tg (° C.) | 77 | 68 | 93 | 94 |
| Bulk density | 0.220 | 0.244 | 0.216 | 0.234 |
| (g/cm³) | | | | |

TABLE 1C
Properties of the ingredient with gas encapsulated under pressure

| | | | 3 comp | |
|---|---|---|---|---|
| | | | Glucose | |
| | 1 comp | 2 comp | syrup | 4 comp |
| | SMP | SMP | based | Maltodextrin |
| | 5% | 15% | 0% | based |
| Test number -> | protein | protein | protein | 0% protein |
| Bulk density - | 0.420 | 0.580 | 0.434 | 0.352 |
| pressurized | | | | |
| (g/cm³) | | | | |
| GTVV (%) | 33 | 21 | 44 | 40 |
| Gas content | 6.4 | 3.2 | 9.6 | 6.8 |
| (ml/gram powder) | | | | |
| Foam test G | 13/11 | 10/9 | 13/11 | 18/13 |
| 1 min/10 min | Fine | Fine | Medium | Medium |
| (mm) | bubbles | bubbles | sized | sized |
| | | | bubbles | bubbles |
| Foam test C | 13/9 | 11/8 | 20/18 | 15/14 |
| 2/10 min | Flocculation | Flocculation | No floc. | No |
| | | | Medium | flocculation |
| | | | sized | Medium |
| | | | bubbles | sized |
| | | | | bubbles |
| pH end (mm) | pH 4.7 | pH 4.7 | pH 3.4 | pH 3.4 |
| Gas leakage (%) | 5/60% | 7/84% | <1/<10% | 3.9/47% |
| in 30 days/1 year | | | | |

(*) Not Applicable. Samples 3 and 4 do not contain any protein.

TABLE 1
Table 1A (Cont.)
General composition. (wt. %)

| | | | | 8 |
|---|---|---|---|---|
| | | 6 comp | 7 comp | WPC- |
| | 5 WPC | Nacas | Nacas | hydrolysate |
| | 2% | 2.5% | 2.5% | 2.5% |
| Test number -> | protein | protein | protein | protein |
| Skimmed milk | | | | |
| powder | | | | |
| Whey protein | 2.5 | | | |
| concentrate | | | | |
| Sodium caseinate | | 2.9 | 2.9 | |
| Whey protein | | | | 2.9 |
| hydrolysate | | | | |
| NOSA modified | | | | |
| starch | | | | |
| Glucose syrup | 97.5 | 97.1 | | 97.1 |
| DE28 | | | | |
| Maltodextrin | | | 97.1 | |
| DE18 | | | | |

TABLE 1B
(Cont.) Properties of the spray dried ingredient before pressurizing

| | | | | 8 |
|---|---|---|---|---|
| | | 6 comp | 7 comp | WPC- |
| Test | 5 WPC | Nacas | Nacas | hydrolysate |
| number -> | 2% protein | 2.5% protein | 2.5% protein | 2.5% protein |
| GTVV (%) | 57 | 61 | 63 | 56 |
| Moisture | 2.8 | 3.6 | 5.3 | 3.6 |
| (wt. %) | | | | |
| Tg (° C.) | 91 | 79 | 85 | 79 |
| Bulk density | 0.282 | 0.262 | 0.262 | 0.284 |
| (g/cm³) | | | | |

TABLE 1C
(Cont.) Properties of the ingredient with gas encapsulated under pressure

| | | | | 8 |
|---|---|---|---|---|
| | | 6 comp | 7 comp | WPC- |
| | 5 WPC | Nacas | Nacas | hydrolysate |
| | 2% | 2.5% | 2.5% | 2.5% |
| Test number -> | protein | protein | protein | protein |
| Bulk density - | 0.470 | 0.373 | 0.382 | 0.522 |
| pressurized | | | | |
| (g/cm³) | | | | |
| GTVV (%) | 42 | 50 | 51 | 37 |
| Gas content | 8.5 | 7.3 | 6.9 | 7.3 |
| (ml/gram powder) | | | | |
| Foam test G | 18/13 | 18/14 | 17/12 | 16/12 |
| 1 min/10 min | Fine | Fine | Fine | Fine |
| (mm) | bubbles | bubbles | bubbles | bubbles |
| Foam test C | 19/16 | 21/20 | 15/14 | 15/13 |
| 2/10 min | No | Flocculation | Flocculation | No |
| | flocculation/ | | | flocculation/ |
| | fine bubble | | | Fine |
| | size | | | bubble size |
| pH end (mm) | pH 4.9 | pH 4.6 | pH 4.7 | pH 3.8 |
| Gas leakage (%) | <1/<10% | 4.2/50% | 9.6/100% | <1/<10% |
| in 30 days/1 year | | | | |

Comparative test numbers 1 and 2 were prepared according to EP 2025238 A1. Comparative test number 3 and 4 were prepared according to WO 2006/023564. The outcome of test 1C can be summarized as follows:
Test nrs. 1 and 2 showed high gas leakage and flocculation in acid liquids—unsuitable;
Test nrs. 3 and 4 showed coarse foam and had an off-taste, very likely caused by the nOSA starch; test nr. 4 also showed high gas leakage—unsuitable; Test nrs. 6 and 7 showed flocculation and extreme gas leakage—unsuitable;
Test nrs. 5 and 8 according to the invention showed fine bubbles, very low gas leakage, no flocculation in acid liquids, and had a supreme taste—very suitable.

### Conclusion:

The results obtained show clearly a huge improvement in gas retention capability of foamer ingredients according to the invention as opposed to those of the prior art. Also, the foam generating power, foam bubble stability, foam bubble quality (amount of microbubbles generated) and mouthfeel is very good. In addition, an excellent acid stability is obtained with the foamer ingredient of the invention (i.e. foamer ingredient of test nr 5).

### Examples 2 (with Test Numbers 1-5)

Samples 1-5 for Examples 2 were Prepared as Follows:

The various proteins and or NOSA starch were dispersed while stirring with a propeller stirring device into hot water of around 50-60° C. After this the carbohydrates (glucose syrup, maltodextrin) were dispersed. For all of the obtained mixes a dry matter content of 60% was applied. The mixture then was heated to 68° C., and then further pumped via a 2-stage homogenizer (operating at low pressures; typically 20/10 bar) to a buffer vessel. From this buffer vessel the liquid was pumped via a high heat pasteurizer (heating until 74-80° C. took place for typically 25-30 seconds) with a high pressure pump with capacity of (approx. 100 kg/hr) to the high pressure atomizer. Within the high pressure tube the injection of gas was done, brought in via a Maximator gas metering device. The gas was fed into the liquid within the high pressure tube with a speed of 0.05 gr/see of nitrogen. Directly after the gas injection point an internal gas mixer dispersed gas further into the liquid feed flow. Further the liquid was fed under high pressure to the Spraying Systems high pressure nozzle and atomized. The high pressure atomization was performed at a pressure of typically 150-170 bar. The liquid was atomized into a drying chamber of Filtermat spray dryer (brand Filtermat, BMA Braunschweig), and subsequently dried under standard conditions. The powder was obtained by applying Tinlet temperatures of 150° C. and outlet temperatures of 75-80° C. The powder was transferred from the last section of the moving belt where some additional free flowing aid (tricalcium phosphate) processing aid was metered onto the moving belt holding the powder with a dosing of 0.1% wt/wt. After the belt the powder was collected passing a sieve with the size of 2 mm. Typical powder moisture contents of 2.5-5.0% were obtained. Bulk densities (loose) of 210-300 g/L were obtained by correctly adjusting the capacity of the liquid feed and the into to this liquid feed metered amount of injected nitrogen gas. The obtained closed pores which were determined by the amount of gas injected were further analysed as GTVV % and were in the range of 45-70%, typically. The powders were characterized by several tests: T_{g}, GTVV %, moisture %, density (g/L) (see table 2).

Boosting Process, Encapsulating Gas within the Obtained Spray Dried Powders:

Below, the process of entrapment of gas within the powdered compositions under high pressure will be described:

The various powders were boosted with nitrogen gas by applying an external gas pressure to the powder (kg) in a rotating double walled vessel that can be pressurized with nitrogen gas (operating up to 35-40 bar) and heated above the powder its Tg, with typical maximum process temperatures (Tmax-powder) that were +25-30° C. higher than their corresponding powder Tg.
The vessel was first filled with powder (20 kg). Then, additional free flowing aid in the form of silicon dioxide E551 (0.8 kg) was added to this as well before closing the vessel, and starting of pressurization (to ensure entrapment of gas), which was performed with the vessel wall temperature between 20-40° C., which is well below its powder Tg. The vessel was heated while rotating (8-10 rpm) until Tmax (C) with a speed of max 3ºC/min, once the Tmax has been reached the vessel heating was stopped and a period of 10 min was used to keep the powder well above T_{g} close to Tmax, and before the cooling with cold water was started with again a speed of max 3° C./min, until the powder reached a temperature 35-40° C. At that moment cooling was stopped, the pressure was released and the powder was removed and collected from the pressure vessel. Again a set of analyses was executed on the obtained powders with gas under high pressure encapsulated: see table 2 as well. Next to the encapsulated gas content, GTVV %, density, the gas content at time zero, also the gas leakage in time was analyzed via the so-called water displacement bag method. With this method non-invasively the products gas release or leakage in time could be followed. Clearly large differences in gas leakage in time were observed for the evaluated variants, showing very unstable, moderately stable and highly stable products after boosting, either holding very little or all most all of their initially encapsulated gas.

TABLE 2
Composition in wt. % of the powders and their characteristics
measured (continued).

| | 1 | 2 | 3 | 4 | 5 |
|---|---|---|---|---|---|
| | 2.7% | 2.7% | 2.5% | 2.5% | 0.9% |
| | protein | protein | protein | protein | protein |
| NOSA | | | | | 7 |
| Glc DE28 | 97 | 97 | 97 | 97 | 92 |
| Solanic 300 | 3 | | | | |
| Puratein HS | | 3 | | | 1 |
| Nutralys S85 | | | 3 | | |
| Radipure E | | | | 3 | |
| GTVV (%) | 55 | 59 | 55 | 57 | 58 |
| (of ingredient | | | | | |
| before | | | | | |
| pressurizing) | | | | | |
| Moisture (wt. %) | 3.2 | 2.7 | 2.9 | 2.8 | 3.2 |
| Tg mid (° C.) | 75 | 93 | 90 | 93 | 87 |
| Bulk density | 240 | 256 | 318 | 277 | 235 |
| (g/cm³) | | | | | |
| Bulk density | 390 | 392 | 487 | 415 | 481 |
| pressurized | | | | | |
| (g/cm³) | | | | | |
| GTVV (%) | 40 | 37 | 35 | 39 | 41 |
| (of ingredient | | | | | |
| with gas | | | | | |
| encapsulated | | | | | |
| under pressure) | | | | | |
| Gas content | 8.2 | 8.2 | 6.4 | 7.5 | 8.2 |
| (ml/gram powder) | | | | | |
| Foam test G | 16/12 | 11/9 | 15/11 | 16/13 | 21/7 |
| 1 min/10 min | | | | | |
| Foam test C | 16/14 | 10/9 | 9/8 | 14/12 | 18/17 |
| 2 min/10 min | | | | | |
| pH end | 3.7 | 4.4 | 4.3 | 4.3 | 4.4 |
| Gas leakage (%) | 1.2/15% | 2.6%/31% | 2%/24% | 1.5%/18% | <1.%/<10% |
| 30 days/year | | | | | |
| extrapolated. | | | | | |

### Example 3: Baking Tests with a Foamer Ingredient According to the Invention (i.e. Test Nr 5 in Table 1)

### Experiment 3A: Chocolate Cookies.

| | | Baking powder |
|---|---|---|
| | Reference (with | replaced by the |
| Ingredients (g) | baking powder) | foamer ingredient |
| Flour | 275 | 260 |
| White castor sugar | 50 | 50 |
| Icing sugar | 100 | 90 |
| Cocoa powder | 40 | 40 |
| Salt | 1 | 1 |
| Baking powder | 7 | |
| Foamer ingredient | | 40 |
| Butter | 100 | 100 |
| Sunflower oil | 100 | 40 |
| Water | 60 | 120 |

### Process:

The foamer ingredient was dispersed in sunflower oil at ambient temperature. The butter was stirred at ambient temperature until smooth using a Hobart planet mixer equipped with a flat beater. All the dry powders were mixed and added to the Hobart bowl. Subsequently, the water was added. The mixture was stirred with speed 1 for 1 minute, and the bowl was scraped. Then the mixture was stirred at speed 2 until a smooth mixture was obtained. The oil dispersion was added (with the foamer ingredient) or the oil was added (reference).
The resulting mixture was stirred at speed 1 until the white spots were gone. The dough so obtained was layered on a flat surface and cut into slabs of 6 cm diameter and 5 mm thickness, using a dough cutter. The dough slabs were placed on a baking tray and baked at 175° C. for 25 minutes in a DEK oven. The resulting chocolate cookies were cooled and packed.

### Experiment 3B: Cupcakes.

| | | Baking powder |
|---|---|---|
| | Reference (with | replaced by the |
| Ingredients (g) | baking powder) | foamer ingredient |
| Cake flour | 122 | 122 |
| Baking powder | 3 | |
| Foamer ingredient | | 20 |
| Sugar, fine | 125 | 120 |
| Whole egg | 100 | 100 |
| Milk | 40 | 40 |
| Sunflower oil | 100 | 100 |

### Process:

The foamer ingredient was dispersed in the sunflower oil at ambient temperature. A pre-mix was prepared of the flour, sugar and baking powder (baking powder only in the reference). All ingredients except the oil dispersion or the oil were put in the Hobart mixing bowl (equipped with a flat beater). The mixture was stirred at speed 1 for half a minute, the bowl was scraped, and the mixture stirred for another half a minute at speed 2. The oil dispersion or the oil was added, and the mixture stirred for about 45 seconds at speed 1. Paper molds were filled with the dough so obtained, and baked at 170ºC for 25 minutes. The resulting cupcakes were cooled and packed.
Sensory assessments of the cookies and the cupcakes:

| | | Chocolate | Cupcakes | |
|---|---|---|---|---|
| | Chocolate | cookies with | with | Cupcakes |
| | cookies with | foamer | baking | with foamer |
| | baking powder | ingredient | powder | ingredient |
| Snap | Crunchy, not too | Crunchy | n.a. | n.a. |
| | hard | | | |
| Taste | Cocoa taste | Good cocoa taste, | A bit | Nice melt in |
| | good, a bit bitter | not bitter or | moist | the mouth, |
| | and astringent, | astringent | | natural taste |
| | salty, fat profile | | | |
| | is pleasant | | | |
| Structure | Fine structure | Sufficiently fine | Good | Very fine |
| | but with some | structure | structure | structure, |
| | layers | | | sufficiently |
| | | | | flexible |

n.a. not applicable

From this experiment it can be concluded that good quality cookies and cupcakes can be made using the foamer ingredient of the invention.

1. A foamer ingredient, comprising:
(a) one or more carbohydrates;
(b) 0.5% to 5% by weight, based on the total weight of the foamer ingredient, of one or more proteins having a protein-bound phosphorus to nitrogen ratio of less than 0.03 g/g and having a proline content of less than 7 g per 100 g of protein; and
(c) entrapped gas,
wherein the foamer ingredient in powder form and releases at least 3 ml of gas per gram of foamer ingredient upon dissolution in 20° C. water at atmospheric pressure.

2. The foamer ingredient according to claim 1, comprising 2% to 5% proteins by weight, based on the total weight of the foamer ingredient.

3. The foamer ingredient according to claim 1, wherein the proteins comprise dairy proteins, plant-based proteins, or a combination thereof.

4. The foamer ingredient according to claim 1, wherein the proteins are selected from the group consisting of potato protein; canola protein; pea protein; faba bean protein; oat protein; rice protein; sunflower protein; lupin protein, corn protein; algal protein; whey protein concentrate; whey protein isolate; and hydrolysates thereof.

5. The foamer ingredient according to claim 1, comprising 85% to 98% by weight of carbohydrates.

6. The foamer ingredient according to claim 1, comprising 88% to 96% by weight of carbohydrates.

7. The foamer ingredient according to claim 1, further comprising one or more additives selected from the group consisting of foam stabilizers, emulsifiers, processing aids, and surfactants.

8. The foamer ingredient according to claim 7, comprising 0-8% additives by weight, based on the total weight of the foamer ingredient.

9. The foamer ingredient according to claim 8, comprising 0.1-6% additives by weight, based on the total weight of the foamer ingredient.

10. The foamer ingredient according to claim 1, wherein the one or more carbohydrates are selected from the group consisting of glucose; glucose syrup; fructose; sucrose; lactose; mannose; maltose; glycerol; propylene glycol; polyglycerols; polyethylene glycols; sorbitol; mannitol; maltitol; lactitol; erythritol; xylitol; maltodextrin; starch hydrolysis products; gums; modified starches such as nOSA-modified starch; modified celluloses; galacto-oligosaccharide (GOS); inulin, oligofructose (FOS); and mixtures thereof.

11. The foamer ingredient according to claim 1, wherein the entrapped gas is selected from the group consisting of nitrogen, carbon dioxide, nitrous oxide, and air.

12. The foamer ingredient according to claim 1, wherein 4 to 20 ml of gas is released, per gram of foamer ingredient, upon dissolution in 20° C. water at atmospheric pressure.

13. The foamer ingredient according to claim 12, wherein 8 to 18 ml of gas is released, per gram of foamer ingredient, upon dissolution in 20° C. water at atmospheric pressure.

14. The foamer ingredient according to claim 1, wherein leakage of gas from the powder upon storage for 12 months at ambient conditions is at most 20%.

15. A method for manufacturing a foamer ingredient, comprising:
(a) preparing a mixture comprising carbohydrates and one or more proteins having a protein-bound phosphorus to nitrogen ratio of less than 0.03 g/g and having a proline content of less than 7 g per 100 g of protein, with the total amount of protein being chosen such that in the foamer ingredient as formed in step (f), the total amount of protein is at least 0.5% by weight and less than 5% by weight, with the mixture being in the form of a powder;
(b) optionally blending the mixture with one or more additives;
(c) applying external gas pressure exceeding atmospheric pressure;
(d) heating the thus obtained mixture to a temperature above 90° C.;
(e) cooling the mixture to a temperature between 40 and 80° C.; and
(f) releasing the external gas pressure, resulting in the foamer ingredient in the form of a powder comprising entrapped gas,
wherein the foamer ingredient releases at least 3 ml of gas per gram of foamer ingredient upon dissolution in 20° C. of water at atmospheric pressure.

16. The method according to claim 15, wherein the atmospheric pressure is between 2 and 4 MPa.

17. The method according to claim 15, wherein the mixture of (a) is prepared using a spray drying technique.

18. A food product comprising the foamer ingredient according to claim 1, wherein the food product is a selected from the group consisting of bakery products, an instant coffee mix, an instant cappuccino mix, instant cocoa mix, an instant tea mix, a dessert product, an ice-cream product, an instant nutrition product, fruit and/or vegetable based beverages, yoghurt, cream cheese, yoghurt, butter milk, smoothies, milkshakes, an instant cheese product, an instant cereal product, an instant soup product, and an instant topping product.
